(19) United States
(12) Patent Application Publication
(10) Pub. No.: US 2025/0326945 A1
(43) Pub. Date: Oct. 23, 2025

(54) INK SET FOR TEXTILE PRINTING, IMAGE FORMING APPARATUS, AND IMAGE FORMING METHOD

(71) Applicant: Konica Minolta, Inc., Tokyo (JP)

(72) Inventors: Masaharu SHIRAISHI, Tokyo (JP); Mai KATO, Tokyo (JP)

(21) Appl. No.: 19/098,193

(22) Filed: Apr. 2, 2025

(30) Foreign Application Priority Data
Apr. 22, 2024 (JP) 2024-069280

(51) Int. Cl. C09D 11/40; B41J 3/407; C09D 11/12; C09D 11/54; D06P 1/52; D06P 1/92; D06P 5/30

(52) U.S. Cl. CPC C09D 11/40; B41J 3/4078; C09D 11/12; C09D 11/54; D06P 1/5257; D06P 1/926; D06P 5/30

(57) ABSTRACT

A ink set for textile printing comprising an inkjet ink and an overcoat layer-forming liquid, in which the volume average particle diameter of wax particles contained in the overcoat layer-forming liquid is twice or more the volume average particle diameter of fixing resin particles contained in the inkjet ink. The fixing resin particle may have a glass transition temperature of −35° C. or lower.

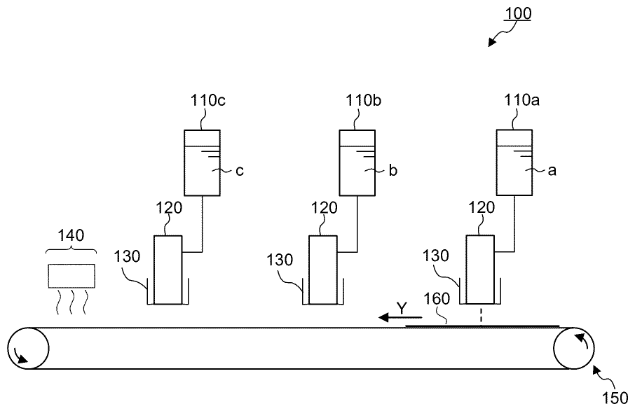

### CROSS REFERENCE TO RELATED APPLICATIONS

The entire disclosure of Japanese Patent Application No. 2024-69280 filed on Apr. 22, 2024, including description, claims, drawings, and abstract, is incorporated herein by reference in its entirety.

### BACKGROUND

### Technological Field

The present invention relates to a ink set for textile printing, an image forming apparatus, and an image forming method.

### Description of Related Art

As a textile printing method, exhaust textile printing in which textile printing is performed by immersing a fabric in a bath filled with a dye has been conventionally known, but since it takes a long time to dye, production efficiency has been low. In recent years, so-called inkjet textile printing, in which an image is formed on a fabric by an inkjet method, has been widely used because dyeing can be performed in a short time and production efficiency is high.

In inkjet textile printing, fine droplets of ink are ejected from an inkjet recording head and landed on a fabric to form an image. For example, Japanese Unexamined Patent Publication No. 2023-31506 discloses a method for producing a textile-printed product by such inkjet.

### SUMMARY

In inkjet textile printing, a textile-printed image formed on a fabric desirably has high friction fastness (wet friction fastness). When the friction fastness of the textile-printed image is low, color transfer or the like such that the color of the textile-printed image is transferred when the textile-printed image is rubbed occurs. In order to solve this problem, the present inventors have investigated adding wax to the inkjet ink used to form the fixing layer of a textile-printed image to reduce the surface friction coefficient of the textile-printed image, thereby enhancing the friction fastness.

However, when wax (wax particles) is added to an inkjet ink, the effect of reducing the surface friction coefficient is insufficient, and the friction fastness is also insufficient. This is presumed to be because even when the wax particles are added to the inkjet ink, the wax particles are covered with the resin particles and the pigment in the inkjet ink, and the amount of the wax present on the surface of the textile-printed image after the drying step is not sufficient.

Furthermore, when an attempt is made to increase the amount of wax particles added in the inkjet ink to produce the effect of reducing the surface friction coefficient, the wax particles inhibit the fixing resin particles in the inkjet ink from binding together. In addition, the ejectability of the inkjet ink was also deteriorated.

An object of the present invention is to provide an ink set for textile-printed images that can form textile-printed images having high friction fastness, an image forming apparatus including the ink set, and an image forming method using the ink set.

### Solution to Problem

The present invention relates to the following ink set for textile printing, image forming apparatus, and image forming method.

[1] A ink set for textile printing, the ink set containing an inkjet ink and an overcoat layer-forming liquid, in which a volume average particle diameter of wax particles contained in the overcoat layer-forming liquid is twice or more a volume average particle diameter of fixing resin particles contained in the inkjet ink.

[2] The ink set for textile printing according to [1], in which the fixing resin particles have a glass transition temperature Tg of −35° C. or lower.

[3] The ink set for textile printing according to [1] or [2], in which the wax particles have a melting point of 80 to 140° C.

[4] The ink set for textile printing according to any one of [1] to [3], in which a content of the wax particles contained in the overcoat layer-forming liquid is 0.1% by mass to 10% by mass with respect to the overcoat layer-forming liquid.

[5] The ink set for textile printing according to any one of [1] to [4], further containing a pretreatment liquid containing a cationic dispersant or a cationic resin.

[6] The ink set for textile printing according to any one of [1] to [5], in which the overcoat layer-forming liquid contains an anionic resin.

[7] An image forming apparatus comprising an ink container that stores the ink set according to any one of [1] to [6].

[8] An image forming method using the ink set according to any one of [1] to [6], the image forming method including performing drying at a temperature equal to or higher than a melting point of the wax particles.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

The FIGURE is a schematic illustration of an image forming apparatus according to the present embodiment.

### DETAILED DESCRIPTION OF EMBODIMENTS

Hereinafter, one or more embodiments of the present invention will be described with reference to the drawings. However, the scope of the invention is not limited to the disclosed embodiments.

As described above, it is difficult to increase the friction fastness of a textile-printed image even when a wax is contained in an inkjet ink.

A ink set for textile printing according to an embodiment of the present invention includes an inkjet ink and an overcoat layer-forming liquid. The inkjet ink is applied onto the fabric to form a fixing layer, and the overcoat layer-forming liquid is applied onto the fixing layer to form an overcoat layer. In the ink set according to the embodiment, the overcoat forming liquid contains wax particles, and the volume average particle diameter of the wax particles is equal to or greater than twice the volume average particle diameter of the fixing resin particles contained in the inkjet ink, and this makes it possible to increase the friction fastness of the textile-printed image. It is presumed that this is because when the size of the wax particles contained in the overcoat layer-forming liquid is as described above, a wax layer is formed on the outermost surface of the textile-printed image to decrease the surface friction coefficient (μ). Details will be described later with reference to Examples.

The ink set for textile printing according to the present embodiment includes an inkjet ink and an overcoat layer-forming liquid. In addition, the ink set for textile printing may include a pretreatment liquid.

The inkjet ink is applied and fixed to the fabric to form a fixing layer. A pretreatment liquid may be applied to fabric before the inkjet ink is applied to the fabric. When the inkjet ink is applied onto the pretreatment liquid, fixing of the fixing layer is promoted. The overcoat layer-forming liquid is applied onto the inkjet ink to form an overcoat layer.

Hereinafter, each of the inkjet ink, the overcoat layer-forming liquid, and the pretreatment liquid will be described.

### 1-1. Inkjet Ink

The inkjet ink (inkjet ink for textile printing) is applied to the fabric to form a fixing layer. The inkjet ink may be applied onto the pretreatment liquid having been applied to the fabric to form a fixing layer. When the inkjet ink is applied onto the pretreatment liquid, aggregation of the fixing resin particles is promoted by the cationic resin contained in the pretreatment liquid. Thus, the fixing of the fixing layer is further promoted.

In the present embodiment, the inkjet ink contains a pigment, fixing resin particles, a surfactant, and an aqueous medium. Hereinafter, each component will be described. The physical properties and preparation of the inkjet ink will also be described.

### (Pigment)

The pigment is not particularly limited, and for example, may be an organic pigment or an inorganic pigment having the following number described in the Color Index.

Examples of orange or yellow pigments include C. I. Pigment Orange 31, C. I. Pigment Orange 43, C. I. Pigment Yellow 12, C. I. Pigment Yellow 13, C. I. Pigment Yellow 14, C. I. Pigment Yellow 15, C. I. Pigment Yellow 17, C. I. Pigment Yellow 74, C. I. Pigment Yellow 83, C. I. Pigment Yellow 93, C. I. Pigment Yellow 94, C. I. Pigment Yellow 128, C. I. Pigment Yellow 138, C. I. Pigment Yellow 151, C. I. Pigment Yellow 154, C. I. Pigment Yellow 155, C. I. Pigment Yellow 180, C. I. Pigment Yellow 185, C. I. Pigment Yellow 213 and the like.

Examples of red or magenta pigments include Pigment Red 3, 5, 19, 22, 31, 38, 43, 48:1, 48:2, 48:3, 48:4, 48:5, 49:1, 53:1, 57:1, 57:2, 58:4, 63:1, 81, 81:1, 81:2, 81:3, 81:4, 88, 104, 108, 112, 122, 123, 144, 146, 149, 166, 168, 169, 170, 177, 178, 179, 184, 185, 208, 216, 226, and 257, Pigment Violet 3, 19, 23, 29, 30, 37, 50, and 88, and Pigment Orange 13, 16, 20, and 36.

Examples of blue or cyan pigments include Pigment Blue 1, 15, 15:1, 15:2, 15:3, 15:4, 15:6, 16, 17-1, 22, 27, 28, 29, 36, and 60.

Examples of green pigments include Pigment Green 7, 26, 36, and 50. Examples of yellow pigments include Pigment Yellow 1, 3, 12, 13, 14, 17, 34, 35, 37, 55, 74, 81, 83, 93, 94, 95, 97, 108, 109, 110, 137, 138, 139, 153, 154, 155, 157, 166, 167, 168, 180, 185, and 193.

Examples of the black pigment include Pigment Black 7, 28, and 26.

Examples of the white pigment include titanium dioxide.

The pigment is preferably further dispersed with a pigment dispersant from the viewpoint of enhancing the dispersibility in the ink. The pigment dispersant will be described later.

The pigment may be a self-dispersible pigment. The self-dispersible pigment is obtained by modifying the surface of a pigment particle with a group having a hydrophilic group, and has a pigment particle and a hydrophilic group bonded to the surface of the pigment particle.

Examples of the hydrophilic group include carboxyl group, sulfonic acid group, and phosphorus-containing group. Examples of the phosphorus-containing group include phosphoric acid group, phosphonic acid group, phosphinic acid group, phosphite group, and phosphate group.

Commercial examples of self-dispersible pigments include Cab-0-Jet (registered trademark) 200K, 250C, 260M, 270 V (sulfonic acid group-containing self-dispersible pigments), Cab-0-Jet (registered trademark) 300K (carboxylic acid group-containing self-dispersible pigments), Cab-0-Jet (registered trademark) 400K, 450C, 465M, 470V, and 480V (phosphoric acid group-containing self-dispersible pigments) from Cabot Corporation.

The content of the pigment is not particularly limited, but is preferably 0.3 to 10% by mass and more preferably 0.5 to 3% by mass with respect to the inkjet ink from the viewpoints of facilitating suitable adjustment of the viscosity of the inkjet ink and enabling formation of a high-density image. When the content of the pigment is equal to or greater than the lower limit value, the color of an image is more likely to be vivid. When the content of the pigment is equal to or less than the upper limit value, the viscosity of the inkjet ink does not become excessively high, and the ejection stability is less likely to be impaired.

### (Fixing Resin Particles)

The fixing resin particles are included for the purpose of fixing the fixing layer onto fabric, and the fixing of the fixing layer also fixes the pigment. The fixing resin particles may be, for example, a water-dispersible resin.

From the viewpoint of enhancing the friction fastness of a textile-printed image, the volume average particle diameter of the fixing resin particles is preferably as follows in relation to the volume average particle diameter of the wax particles contained in the overcoat layer-forming liquid. That is, the volume average particle diameter of the fixing resin particles is preferably ½ or less of the volume average particle diameter of the wax particles contained in the overcoat layer-forming liquid. The volume average particle diameter of the fixing resin particles can be measured with an Zataizer Nano S90 manufactured by Melvern Instruments Inc.

More particularly, the volume average particle diameter of the fixing resin particles is, for example, about 30 to 40 nm, or about 35 nm.

The fixing resin particles preferably have a low glass transition temperature (Tg) from the viewpoints that fabric is less likely to become hard even after image formation and satisfactory texture is maintained. Specifically, the Tg of the fixed resin particles is preferably −35° C. or less, and preferably −35 to −70° C. The glass transition temperature (Tg) of the fixing resin particles can be measured at a heating rate of 10° C./min in accordance with JIS K 7121.

The Tg of the fixing resin particles can be adjusted by the type of the fixing resin particles and the monomer composition. For example, in the case of a (meth)acrylic resin, as the content of the constitutional unit (a) derived from alkyl acrylate is increased, the Tg is more likely to be lowered.

The type of the fixing resin particles is not particularly limited as long as the Tg satisfies the above range. Examples of the fixing resin particles include (meth)acrylic resin, polyurethane resin, and polyester resin. Among these, a (meth)acrylic resin and a polyurethane resin are preferable from the viewpoints of having satisfactory flexibility and being more likely to maintain the texture of the fabric. In the present specification, (meth)acryl represents acryl, methacryl, or both of them.

The fixing resin particles may also have an ionic group. The ionic group of the fixing resin particle may be an ionic group that forms a pair with an ionic group of the pretreatment liquid adhering to the fabric. For example, since the pretreatment liquid usually has a cationic group, the fixing resin particles contained in the inkjet ink may have an anionic group. Examples of the anionic group include carboxyl group, sulfonic acid group and phosphonic acid group.

The (meth)acrylic resin is a polymer including a constitutional unit derived from a (meth)acrylic monomer.

The (meth)acrylic monomer is a monomer having a (meth)acryloyl group, and examples thereof include (meth)acrylic acid, (meth)acrylic acid alkyl esters, and (meth)acrylamides. Note that (meth)acryl is a concept including both methacryl and acryl. Among them, (meth)acrylic acid alkyl ester is preferable.

That is, it is preferable that the (meth)acrylic resin include a constitutional unit (a) derived from (meth)acrylic acid alkyl ester, and further include a constitutional unit (b) derived from an unsaturated compound having an anionic group, from the viewpoints of enhancing water dispersibility and aggregability, and the like.

The constitutional unit (a) is derived from a (meth)acrylic acid alkyl ester. In view of lowering Tg of the resin, the (meth)acrylic acid alkyl ester preferably includes an acrylic acid alkyl ester. The alkyl group of the acrylic acid alkyl ester has a carbon number of, for example, 1 to 20, preferably 4 to 12, and more preferably 4 to 8. Examples of the acrylic acid alkyl ester include butyl acrylate, pentyl acrylate, hexyl acrylate, heptyl acrylate, and 2-ethylhexyl acrylate, and butyl acrylate is preferable.

The (meth)acrylic acid alkyl ester may be used alone or in combination of two or more types thereof. For example, an acrylic acid alkyl ester and an methacrylic acid alkyl ester may be used in combination.

The content of the constitutional unit (a) is not particularly limited, but is preferably 70 to 96% by mass with respect to the total constitutional units constituting the (meth)acrylic resin. When the content is 70% by mass or more, the Tg of the resin is more easily lowered. When the content is 96% by mass or less, friction resistance and the like are less likely to be impaired. From the same viewpoint, the content is more preferably 80 to 90% by mass with respect to the total constitutional units constituting the (meth)acrylic resin.

The constitutional unit (b) is derived from an unsaturated compound having an anionic group. Examples of the unsaturated compound having a carboxy group include ethylenically unsaturated carboxylic acids such as acrylic acid, methacrylic acid, crotonic acid, itaconic acid, maleic acid, fumaric acid, and 2-acryloyloxyethylsuccinic acid.

Examples of the unsaturated compound having a sulfonic acid group include vinylsulfonic acid, styrenesulfonic acid, and allylsulfonic acid. Examples of the unsaturated compound having a phosphate group include vinylphosphonic acid and 2-((meth)acryloyloxy) ethyl phosphate. Among these, ethylenically unsaturated carboxylic acids are preferable.

The content of the constitutional unit (b) is not particularly limited, but is preferably 3 to 15% by mass with respect to the total constitutional units constituting the (meth)acrylic resin. When the content is 3% by mass or more, the dispersibility and the aggregation property of the fixing resin particles in the ink are further easily enhanced. When the content is 15% by mass or less, the viscosity of the ink is less likely to be increased and the ejection stability is less likely to be impaired. From the same viewpoint, the content of the constitutional unit (b) is more preferably 3 to 10% by mass with respect to the total constitutional units constituting the (meth)acrylic resin.

The (meth)acrylic resin may further include a constitutional unit (c) derived from another monomer other than the above-described monomers. Examples of the other monomers include monofunctional monomers such as ethylenically unsaturated carboxylic acids (e.g., maleic acid and itaconic acid); styrenes (e.g., styrene, a-methylstyrene, and vinyl toluene); saturated vinyl fatty acids (e.g., vinyl acetate and vinyl propionate); vinyl compounds (e.g., 1,4-divinyloxybutane and divinylbenzene); allyl compounds (e.g., diallyl phthalate and triallyl cyanurate); and acrylamide; and difunctional or higher functional monomers such as polyfunctional (meth)acrylates such as diethylene glycol di(meth)acrylate, 1,6-hexanediol di(meth)acrylate, propylene glycol di(meth)acrylate, and N,N′-methylene bis(acrylamide), and polyfunctional acrylamide.

Examples of commercially available products of the (meth)acrylic resin include EMN-325 (Acryset, acrylic elastomer, Tg −50° C., manufactured by Nippon Shokubai Co., Ltd), EMN-326 (Acryset, acrylic elastomer, Tg −50° C., manufactured by Nippon Shokubai Co., Ltd), and the like.

The urethane resin is a thermoplastic urethane resin. The thermoplastic urethane resin may be, for example, a reaction product of a low molecular weight diol as a chain extender, a polyisocyanate, and a polyol. In addition, the urethane resin is preferably a self-emulsifying type. The self-emulsifying urethane resin may be, for example, a reaction product of a low molecular weight diol as a chain extender, a polyisocyanate having an anionic group, and a polyol.

The low molecular weight diol is a difunctional aliphatic oligomer of glycol. Typical difunctional aliphatic oligomers of glycols include, for example, ethylene glycol, propylene glycol, 1, 4 butanediol, 1, 6 hexanediol, and the like.

The polyisocyanate is preferably a diisocyanate, and examples thereof include aromatic diisocyanates such as diphenylmethane diisocyanate, for example, 4,4′-diphenylmethane diisocyanate and 2,4′-diphenylmethane diisocyanate, and aliphatic diisocyanates such as 4,4′-dicyclohexylmethane diisocyanate and 2,4′-dicyclohexylmethane diisocyanate.

The polyol may be a polyester polyol or may be a polyether polyol. Examples of polyester polyols may be the reaction product of a polycarboxylic acid and a polyol. Examples of polycarboxylic acids include malonic acid, citric acid, succinic acid, glutaric acid, adipic acid, pimelic acid, azelaic acid, sebacic acid, maleic acid, fumaric acid, terephthalic acid, phthalic acid. Examples of the polyol to be reacted with the polycarboxylic acid include trimethylolpropane, trimethylolethane, 2-methylglucoside, sorbitol, low-molecular-weight polyols, for example, polyoxyethylene glycol, polyoxypropylene glycol, and block heteropolyoxyethylene-polyoxypropylene glycol, and the like.

The thermoplastic polyurethane includes a hard segment and a soft segment in the molecule. The hard segment may be mainly a moiety produced by the reaction of polyisocyanate and a low molecular weight diol; and the soft segment may be mainly a moiety of polyol.

The mass ratio of the hard segment to the soft segment in the polymer chain of the thermoplastic polyurethane is, for example, 75/25 to 15/85 (mass ratio), preferably 60/40 to 25/75 (mass ratio). From the viewpoint of lowering Tg, the mass ratio of the soft segment may be increased, for example, the mass ratio of the soft segment may be higher than that of the hard segment.

Examples of commercially available products of thermoplastic polyurethanes include Elastollan 1185A (manufactured by BASF, thermoplastic polyurethane elastomer, Tg −41° C.).

The acid value of the fixing resin particles is not particularly limited, but is preferably 15 to 100 mgKOH/g and more preferably 20 to 80 mgKOH/g from the viewpoint of further enhancing friction fastness. The acid value of the toner can be measured according to JIS K 0070.

The acid value of the fixing resin particles can be adjusted by the content of the constitutional unit (b). For example, when the content of the constitutional unit (b) derived from an unsaturated compound having an acidic group is increased, the acid value is increased.

The weight average molecular weight Mw of the fixing resin particles is preferably high from the viewpoint of improving the texture of the textile-printed image formed product while improving the friction fastness, and is preferably 6×10⁵ or more, 7×10⁵ or more, 8×10⁵ or more, 10×10⁵ or more, or 11×10⁵ or more. The upper limit of the weight average molecular weight Mw of the fixing resin particles may be, for example, 40×10⁵ or less, or 30×10⁵ or less.

From the viewpoint of improving the ejectability of the inkjet ink, the ratio Mw/Mn of the weight average molecular weight Mw to the number-average molecular weight Mn of the fixing resin particles is preferably 5 to 20, more preferably 5 to 15, and still more preferably 5 to 12. A small Mw/Mn ratio means that the molecular weight distribution is small, and that the amount of low molecular weight fixing resin particles (for example, monomers or oligomers) is small. Fixing resin particles having a low molecular weight is considered to have an adverse effect on the ejectability of the inkjet ink for textile printing.

A method of obtaining the fixing resin particles having a high molecular weight as described above is not particularly limited, and examples thereof include a method of polymerizing a monomer with a small amount of a polymerization initiator, and polymerization (RAFT polymerization) using a reversible addition-fragmentation chain transfer agent (RAFT agent). In particular, RAFT polymerization is useful and preferable for decreasing Mw/Mn while increasing the weight average molecular weight Mw of the fixing resin particles.

Examples of the RAFT agent include 2-cyano-2-[(dodecylsulfanylthiocarbonyl) sulfanyl]propane (manufactured by FUJIFILM Wako Pure Chemical Industries, Ltd), 4-cyano-4-dodecylsulfanylthiocarbonylsulfanylpentanoic acid (manufactured by FUJIFILM Wako Pure Chemical Industries, Ltd), and bisthiobenzoyl disulfide (manufactured by Tokyo Chemical Industry Co., Ltd).

Both the weight average molecular weight Mw and the number average molecular weight Mn of the fixing resin particles can be measured by gel permeation chromatography in terms of polystyrene.

The content of the fixing resin particles is not particularly limited, but is preferably 1 to 20% by mass with respect to the total mass of the inkjet ink for textile printing. When the content of the fixing resin particles is equal to or greater than 1% by mass, it is easy to further increase the fixability of the inkjet ink for textile printing to fabric. When the content of the fixing resin particles is 20% by mass or less, the texture is less likely to be impaired. From the same viewpoint, the content of the fixing resin particles is more preferably 5 to 15% by mass with respect to the total mass of the inkjet ink for textile printing.

### (Surfactant)

The surfactant can be added mainly for the purpose of suppressing adhesion of the fixing resin particles to the nozzle surface of a recording head from which the inkjet ink is ejected. The surfactant is not particularly limited as long as the surfactant has affinity with the fixing resin particles. Such a surfactant is preferably a nonionic surfactant.

The nonionic surfactant is a surfactant that does not include an ionic group. Examples of the nonionic surfactant include the following:
acetylene glycol-based surfactants such as acetylene glycol and ethylene oxides and/or propylene oxide adducts of acetylene glycol (e.g., 2,4,7,9-tetramethyl-5-decyne-4, 7,-diol, 3,6-dimethyl-4-octyne-3,6-diol, and the like, and ethylene oxides and/or propylene oxide adducts thereof);
acetylene alcohol-based surfactants such as acetylene alcohols and ethylene oxides and/or propylene oxide adducts of acetylene alcohols (e.g., 3,5-dimethyl-1-hexane-3-ol and the like and ethylene oxides and/or propylene oxide adducts thereof);
ether-based surfactants such as polyoxyethylene nonyl phenyl ether, polyoxyethylene octyl phenyl ether, polyoxyethylene dodecyl phenyl ether, polyoxyethylene alkyl allyl ether, polyoxyethylene oleyl ether, polyoxyethylene lauryl ether, polyoxyethylene alkyl ether, and polyoxyalkylene alkyl ether;
ester-based surfactants such as polyoxyethylene oleic acid, polyoxyethylene oleic acid ester, polyoxyethylene distearic acid ester, sorbitan laurate, sorbitan monostearate, sorbitan monooleate, sorbitan sesquioleate, polyoxyethylene monooleate, and polyoxyethylene stearate;
polyether-modified siloxane-based surfactant such as dimethylpolysiloxane; and
fluorine-containing surfactants such as fluoroalkyl esters and perfluoroalkyl carboxylates.

These surfactants may be commercially available products. For example, commercially available examples of the polyether-modified siloxane compound include TEGO Wet240, TEGO WetKL245, TEGO Wet250, TEGO Wet260, TEGO Wet265, TEGO Wet280, manufactured by Evonik Industries AG, and LPX23288, LPX23289, LPX23347, BYK-348, and BYK-349 manufactured by BYK. Examples of commercial products of the acetylene glycol surfactant and the acetylene alcohol surfactant include Olfine E1010, Olfine EXP. 4036, Olefin EXP. 4123, Surfynol 465, and Surfynol 485 manufactured by Nissin Chemical Industry Co., Ltd. Examples of commercially available products of ether-based surfactants include EMULGEN 106 (polyoxyethylene lauryl ether) and EMULGEN 709 (polyoxyethylene higher alkyl ether) manufactured by Kao Corporation, and DYNWET800 and DYNWET800N (both are alcohol alkoxylates) manufactured by BYK.

Among these, acetylene glycol-based surfactants and acetylene alcohol-based surfactants are preferable, and ethylene oxide adducts of acetylene glycol are more preferable, from the viewpoints that affinity with the water-dispersible resin is better, and adhesion of the resin to a head is more easily suppressed.

The content of the surfactant is preferably 0.1 to 10% by mass with respect to the inkjet ink. When the content of the surfactant is 0.1% by mass or more, the adhesion of the resin to the head is more easily suppressed. When the content of the surfactant is 10% by mass or less, the friction fastness of the obtained image formed product is further less likely to be impaired. From this viewpoint, the content of the surfactant is more preferably 0.1 to 5% by mass with respect to the ink.

### (Aqueous Medium)

The aqueous medium is not particularly limited, but preferably contains water, and preferably further contains a water-soluble organic solvent.

The content of the water is, for example, 20 to 70% by mass, and preferably 30 to 60% by mass with respect to the inkjet ink.

The water-soluble organic solvent is not particularly limited as long as it is compatible with water, but it is preferable that the inkjet ink does not easily thicken due to drying, from the viewpoint of making it easy for the inkjet ink to penetrate into the inside of the fabric, and from the viewpoint of making it difficult for the ejection stability in the inkjet system to be impaired. Therefore, the inkjet ink preferably contains a high-boiling-point solvent having a boiling point of 200° C. or higher.

The high-boiling point solvent having a boiling point of 200° C. or higher may be a water-soluble organic solvent having a boiling point of 200° C. or higher, and is preferably a polyol or a polyalkylene oxide.

Examples of the polyols having a boiling point of 200° C. or higher include dihydric alcohols such as 1,3-butanediol (boiling point: 208° C.), 1,6-hexanediol (boiling point: 223° C.), and polypropylene glycol; and trihydric or higher hydric alcohols such as glycerin (boiling point: 290° C.), and trimethylolpropane (boiling point: 295° C.).

Examples of the polyalkylene oxides having a boiling point of 200° C. or higher include ethers of dihydric alcohols such as diethylene glycol monoethyl ether (boiling point: 202° C.), triethylene glycol monomethyl ether (boiling point: 245° C.), tetraethylene glycol monomethyl ether (boiling point: 305° C.), tripropylene glycol monoethyl ether (boiling point: 256° C.), and polypropylene glycol; and ethers of trihydric or higher alcohols such as glycerin (boiling point: 290° C.) and hexanetriol.

The aqueous medium may further contain a solvent other than the high-boiling point solvent. Examples of the other solvents include polyhydric alcohols having a boiling point of lower than 200° C. (e.g., ethyleneglycol, propyleneglycol, hexanetriol, etc); polyhydric alcohol ethers having a boiling point of lower than 200° C. (e.g., ethyleneglycol monomethylether, ethyleneglycol monobutylether, diethyleneglycol monomethylether, diethyleneglycol dimethylether, propyleneglycol monomethylether, and propyleneglycol monoethylether); monohydric alcohols (e.g., methanol, ethanol, propanol, pentanol, hexanol, cyclohexanol, and benzylalcohol); amines (e.g., ethanol amine, N-ethyldiethanolamine, morpholine, N-ethylmorpholine, ethylene diamine, diethylene diamine, and triethylene tetramine); amides (e.g., formaldehyde, N,N-dimethylformamide, and N,N-dimethylacetamide); heterocycles (e.g., 2-pyrrolidone, N-methyl-2-pyrrolidone, N-cyclohexyl-2-pyrrolidone, 2-oxazolidone, and 1,3-dimethyl-2-imidazolidine); sulfoxides (e.g., dimethylsulfoxide); and sulfones (e.g., sulfolane).

The content of the water-soluble organic solvent is, for example, 20 to 70% by mass, and preferably 30 to 60% by mass, with respect to the inkjet ink.

### (Other Components)

The inkjet ink may further contain other components, when necessary. Examples of the other components include pigment dispersants, antiseptics, antifungal agents, and pH adjusters.

The pigment dispersant is present in the ink in such a manner as to surround the surfaces of pigment particles or is adsorbed onto the surfaces of pigment particles to form a pigment dispersion liquid and thereby satisfactorily disperse the pigment. The pigment dispersant is preferably a polymer dispersant, more preferably an anionic polymer dispersant.

The anionic polymer dispersant is a polymer dispersant having a hydrophilic group such as a carboxylic acid group, a phosphorus-containing group, or a sulfonic acid group, and is preferably a polymer dispersant having a carboxylic acid group.

The polymer dispersant having a carboxylic acid group may be a polycarboxylic acid or a salt thereof. Examples of the polycarboxylic acid include (co)polymers of monomers selected from acrylic acid or a derivative thereof, maleic acid or a derivative thereof, itaconic acid or a derivative thereof, and fumaric acid or a derivative thereof, and salts thereof. Examples of other monomers constituting the copolymer include styrene and vinylnaphthalene.

The anionic polymer dispersant preferably has an anionic group equivalent weight of, for example, 1.1 to 3.8 meq/g in order to sufficiently disperse the pigment particles. When the anionic group equivalent weight is within the above range, high pigment dispersibility is easily obtained without increasing the molecular weight of the anionic polymer dispersant. The anionic group equivalent weight of the anionic polymer dispersant can be determined from the acid value. The acid value can be measured in accordance with JIS K0070.

The weight average molecular weight Mw of the polymer dispersant is not particularly limited, but is preferably 5000 to 30000. When the Mw of the polymer dispersant is 5000 or more, the pigment particles are easily and sufficiently dispersed, and when the Mw is 30000 or less, the ink is not excessively thickened, and therefore, the permeability into fabric is hardly impaired. The Mw of the polymer dispersant can be measured by the same method as described above.

The content of the polymer dispersant is not particularly limited as long as the polymer dispersant sufficiently disperses pigment particles and has a viscosity to the extent that the permeability into fabric is not impaired, but the content is preferably 20 to 100% by mass and more preferably 25 to 60% by mass with respect to the pigment.

Examples of the antiseptic or antifungal agent include aromatic halogen compounds (e.g., Preventol CMK), methylene dithiocyanate, halogen-containing nitrogen-sulfur compounds, 1,2-benzisothiazolin-3-one (e.g., PROXEL GXL), and the like.

Examples of the pH adjuster include citric acid, sodium citrate, hydrochloric acid, and sodium hydroxide.

### (Physical Property)

The viscosity of the inkjet ink at 25° C. is not particularly limited as long as the ejection property by an inkjet method become satisfactory, but is preferably 3 to 20 mPa·s, and more preferably 4 to 12 mPa·s. The viscosity of the ink can be measured at 25° C. using an E-type viscometer.

### (Preparation of Inkjet Ink)

The inkjet ink can be produced by any method. For example, an inkjet ink can be produced through steps of 1) mixing a pigment, a pigment dispersant, and a solvent (such as water) to obtain a pigment dispersion liquid, and 2) further mixing the obtained pigment dispersion liquid, a dispersion containing the above-described water-dispersible resin (resin particle dispersion), an aqueous medium, and the like.

The adhesion amount of the textile-printed image may be from 1 g/m² to 10 g/m², more preferably from 3 g/m² to 10 g/m², and still more preferably from 3 g/m² to 8 g/m².

The fabric on which the textile-printed image is formed is not particularly limited as long as the textile-printed image can be formed. Examples of the type of fiber material forming the fabric include natural fibers such as cotton (cellulose fiber), hemp, wool, and silk; and chemical fibers such as rayon, vinylon, nylon, acrylic, polyurethane, polyester, and acetate. The fabric may be any form of these fibers, such as a woven fabric, a nonwoven fabric, and a knitted fabric. In addition, the fabric may be a blended woven fabric or a blended nonwoven fabric of two or more types of fibers. The fabric is preferably, for example, cotton satin.

As described above, the textile-printed image formed product according to the present embodiment includes a textile-printed image formed on fabric. The textile-printed image may have a pretreatment layer, a fixing layer, and an overcoat layer.

### 1-2. Pretreatment Liquid

The pretreatment liquid may be used for further promoting fixing of a fixing layer formed by the inkjet ink. Specifically, the pretreatment liquid contains a cationic dispersant or a cationic resin, and the cationic dispersant or the cationic resin promotes aggregation of the fixing resin particles and the pigment in the inkjet ink to promote fixing of the fixing layer. When a pretreatment liquid is used, the pretreatment liquid is first applied to the fabric. The pretreatment liquid applied onto the fabric becomes a pretreatment layer.

The weight average molecular weight Mw of the cationic resin is preferably 1000 or more from the viewpoint of suppressing the stickiness of a textile-printed image. On the other hand, the upper limit of the weight average molecular weight of the cationic resin is preferably 10,000 or less from the viewpoint of dispersibility in the pretreatment liquid. That is, the weight average molecular weight of the cationic resin is preferably 1000 to 10000. The weight average molecular weight Mw of the cationic resin can be measured by gel permeation chromatography in terms of polystyrene.

Examples of the cationic resin include polyamine, diallylamine hydrochloride polymer, diallylamine polymer, methyldiallylamine hydrochloride polymer, methyldiallylamine amide sulfate polymer, methyldiallylamine acetate polymer, diallyldimethylammonium chloride polymer, diallylmethylethylammonium ethylsulfate polymer, amine-epichlorohydrin condensation type polymer, poly-2-hydroxypropyldimethylammonium chloride, dimethylamine-ethylenediamine-epichlorohydrin condensate, dimethylamine-ammonia-epichlorohydrin condensate, and the like.

Examples of commercially available products of the cationic resins include PAS-H-K manufactured by Nittobo Medical Co., Ltd., KAITHIOMASTER (registered trademark) PD-7, PD-30, and PE-30 manufactured by Yokkaichi Gosei 1 L. Ltd, and UNISENCE KHE manufactured by Senka Corporation.

The content of the cationic resin is preferably 0.1% by mass to 10% by mass with respect to the total mass of the pretreatment liquid.

The method of applying the pretreatment liquid is not particularly limited and may be, for example, a pad method, a coating method, a spraying method, an inkjet method, or the like. The pretreatment liquid applied to the fabric may be heated and dried with warm air, a hot plate, or a heat roller.

### 1-3. Overcoat Layer-Forming Liquid

The overcoat layer-forming liquid is applied onto the pretreatment liquid and the inkjet ink that have been applied to the fabric. The overcoat layer-forming liquid applied to the fabric forms an overcoat layer. The overcoat layer can reduce the surface friction coefficient of the textile-printed image.

The overcoat layer-forming liquid contains wax particles. The volume average particle diameter of the wax particles is twice or more the volume average particle diameter of the fixing resin particles contained in the inkjet ink, and may be 2.5 times or more, 3 times or more, or 3.5 times or more. The upper limit of the volume average particle diameter of the wax particles is not particularly limited, but is, for example, 10 times or less or 5 times or less. As described above, it is presumed that when the size of the wax particles contained in the overcoat layer-forming liquid is larger than that of the fixing resin particles in the inkjet ink, a wax layer is formed on the outermost surface of a textile-printed image, the surface friction coefficient (μ) of the textile-printed image decreases, and the friction fastness of the textile-printed image becomes satisfactory.

More specifically, the volume average particle diameter of the wax particles contained in the overcoat layer-forming liquid is, for example, 80 nm or more, 90 nm or more, or 100 nm or more. The upper limit of the volume average particle diameter of the wax particles is not particularly limited, and is, for example, 350 nm or less, 200 nm or less, 190 nm or less, or 180 nm or less.

The volume average particle diameter of the wax particles can be measured with an Zataizer Nano S90 manufactured by Melvern Instruments Inc.

The melting point of the wax particles contained in the overcoat layer-forming liquid is preferably equal to or lower than the drying temperature described in the method of forming a textile-printed image described later. It is considered that when the melting point of the wax particles is equal to or lower than the drying temperature, the wax particles melt, a wax layer is formed on the surface of the textile-printed image, the surface friction coefficient of the textile-printed image decreases, and the friction fastness becomes satisfactory. The melting point of the wax particles contained in the overcoat layer-forming liquid is, for example, about 80° C. to 140° C. or about 85° C. to 135° C.

Examples of the wax particles include polyolefin wax particles, polyethylene wax particles, and modified polyethylene wax particles. The content of the wax particles is preferably 0.1% by mass to 10% by mass with respect to the total mass of the overcoat layer-forming liquid.

The overcoat layer-forming liquid may contain anionic resin particles (anionic resin). The amount of the anionic resin particles added to the overcoat layer-forming liquid is, for example, 15% or less as the total solid content with respect to the overcoat layer-forming liquid. The volume average particle diameter of the anionic resin particles can be measured with an Zataizer Nano S90 manufactured by Melvern Instrument Inc.

The anionic resin particles preferably have a glass transition temperature Tg of 50° C. or higher, more preferably 100° C. or higher. The glass transition temperature Tg of the anionic resin particles can be measured by differential scanning calorimetry at a heating rate of 10° C./min in accordance with JIS K 7121.

Examples of the anionic resin particles include particles of a polymer having a functional group capable of carrying a negative charge. Examples of such a functional group include a carboxyl group, a hydroxyl group, and a sulfate group.

Examples of commercially available products of the anionic resin particles include AQUACER507 manufactured by BYK and Hitec E-4A manufactured by Toho Chemical Industry Co., Ltd.

The content of the anionic resin particles is preferably 2% by mass to 6% by mass, and more preferably about 4% by mass, with respect to the overcoat layer-forming liquid.

The overcoat layer-forming liquid may contain a fixing resin. The fixing resin contained in the overcoat layer-forming liquid may be the same as the fixing resin contained in the inkjet ink.

The method for applying the overcoat layer-forming liquid is not particularly limited, and may be, for example, a pad method, a coating method, a spraying method, or an inkjet method. The overcoat layer-forming liquid applied to the fabric may be heated and dried using warm air, a hot plate, or a heat roller.

### 2. Image Forming Apparatus and Image Forming Method

### 2-1. Image Forming Apparatus

An outline of an image forming apparatus used for forming a textile-printed image according to the invention will be described.

The FIGURE is a schematic diagram which shows an outline of an embodiment of an image forming apparatus 100 used for forming a textile-printed image.

As illustrated in the FIGURE, the image forming apparatus 100 includes a pretreatment liquid container 110a, an ink container 110b, an overcoat layer-forming liquid container 110c, recording heads 120, head carriages 130, a drying section 140, and a conveyance section 150.

The pretreatment liquid container 110a, the ink container 110b, and the overcoat layer-forming liquid container 110c respectively accommodate a pretreatment liquid a, an inkjet ink b, and a overcoat layer-forming liquid c, and are arranged in this order from the upstream side to the downstream side in the transport direction Y of the fabric 160. The fabric 160 is conveyed by the conveyance section 150.

The pretreatment liquid container 110a, the ink container 110b, and the overcoat layer-forming liquid container 110c supply the pretreatment liquid a, the inkjet ink b, and the overcoat layer-forming liquid c to the recording heads 120 connected thereto, respectively, and the recording heads 120 eject the pretreatment liquid a, the inkjet ink b, and the overcoat layer-forming liquid c onto the fabric 160, respectively, to form a textile-printed image.

A plurality of ink containers 110b and a plurality of corresponding recording heads 120 may be disposed, for example, for the respective colors of ink.

The head carriage 130 with the recording head 120 described above mounted thereon scans the recording head 120 in a main scanning direction substantially orthogonal to the conveyance direction Y of the fabric 160. The recording head 120 may move integrally with or separately from the container 110b.

The drying section 140 is disposed on the downstream side of the containers and recording heads 120 in the transport direction Y. The drying section 140 may be a heating means such as a hot air dryer that blows hot air, a heater that irradiates infrared rays or ionizing radiation, or a heating roller. The drying section 140 dries a textile-printed image formed on the fabric 160. From the viewpoint of melting the wax particles contained in the overcoat layer-forming liquid, the drying temperature is preferably higher than the melting point of the wax particles. The drying temperature may be, for example, about 85 to 160° C. to make it higher than the melting point of the wax particles. In the present embodiment, the drying temperature is 150° C.

### 2-2. Image Forming Method

Next, the method for producing a textile-printed image formed product will be specifically described with reference to the FIGURE. The method for producing a textile-printed image formed product according to the present embodiment includes the steps of 1) ejecting a pretreatment liquid, an inkjet ink, and an overcoat layer-forming liquid in this order from respective recording heads 120 onto a fabric to adhere the liquids to the fabric, and 2) drying the fabric to which the liquids have adhered at a temperature higher than the melting point of wax particles included in the overcoat layer.

### Step 1)

First, the pretreatment liquid, the inkjet ink, and the overcoat layer-forming liquid are ejected in this order from respective recording heads 120 to form a pretreatment layer on the fabric 160 moving in the transport direction Y, a fixing layer on the pretreatment layer, and an overcoat layer on the fixing layer, thereby forming a textile-printed image.

### Step 2)

Next, the textile-printed image formed on the fabric 160 is dried by the drying section 140 to remove the solvent component in the ink. Thus, the pigment is fixed to the fabric 160. Thus, a textile-printed image formed product is obtained.

The drying method is not particularly limited, and may be a method using a heater, a hot air dryer, a heating roller, or the like. In the present embodiment, it is preferable to heat and dry both sides of the fabric by the drying section 140 using a hot-air dryer and a heater.

From the viewpoint of melting the wax particles contained in the overcoat layer-forming liquid, the drying temperature is preferably higher than the melting point of the wax particles. The drying temperature is preferably set so as to volatilize the solvent contained in each liquid to some extent. From these viewpoints, the drying temperature can be, for example, about 85 to 160° C. In the present embodiment, the drying temperature is 150° C.

### EXAMPLES

Hereinafter, the present invention will be specifically described with reference to Examples, but the present invention is not limited thereto.

### Example 1

A pretreatment liquid, an inkjet ink, and an overcoat layer-forming liquid to be used for obtaining a textile-printed image in Example 1 were obtained as follows.

### 1-1. Pretreatment Liquid

The following components were mixed in the following proportions based on 100 parts by mass of the pretreatment liquid to obtain a pretreatment liquid.
PAS-H-1L (manufactured by NittoBo Medical Co., Ltd) as a cationic resin: 4.7 parts by mass
Ethylene glycol: 10 parts by mass
Propylene glycol: 10 parts by mass
Glycerin: 10 parts by mass
Surfactant E-1010: 0.1 parts by mass
Proxel GXL (manufactured by Lonza Japan Ltd., 1,2-benzisothiazolin-3-one, antifungal agent): 0.10 parts by mass
Ion-exchanged water: Remaining part

### 1-2. Inkjet Ink

The inkjet ink contains a pigment (pigment dispersion liquid), fixing resin particles, a surfactant, a water-soluble organic solvent, and an antifungal agent. These components were prepared as follows.

Seven parts by mass of styrene-butyl acrylate-methacrylic acid as a pigment dispersant (anionic dispersant, weight average molecular weight of 16000, anionic-group-equivalent weight of 3.5 meq/g) was mixed with 78 parts by mass of water, followed by heating and stirring, to prepare a neutralized product of the pigment dispersant. To this mixture, 15 parts by mass of C. I. Pigment Blue 15:3 was added and premixed, and then the mixture was dispersed using a sand grinder filled with 50% by volume fraction of 0.5 mm zirconia beads to obtain a cyan pigment dispersion liquid having a pigment concentration of 15% by mass.

As the surfactant, E-1010 (manufactured by Nissin Chemical Industry Co., Ltd) was used.

As the water-soluble organic solvent, ethylene glycol (boiling point: 197° C.), glycerin (boiling point: 290° C.), and propylene glycol (boiling point: 188° C.) were used.

Proxel GXL (manufactured by Lonza Japan Ltd., 1,2-benzisothiazolin-3-one) was used as the antifungal agent.

As the fixing resin particles, polyurethane-based resin (TAKELAC WS-5000 manufactured by Mitsui chemicals, Inc., Tg: 65° C.) was used. The volume average particle diameter of the polyurethane polymer was measured with Zataizer Nano S90 manufactured by Melvern and found to be 35 nm.

The glass transition temperature Tg of the fixing resin particles can be measured with a DSC600 manufactured by Hitachi High-Technologies Corporation in accordance with JIS K7121 at a temperature gradient of 10° C./min.

An inkjet ink was obtained by mixing the above components in the following proportions, based on the mass of the inkjet ink as 100 parts by mass.

Pigment dispersion liquid: 10 parts by mass (pigment concentration of 15% by mass, solid concentration of 1.5 parts by mass)
Fixing resin particles: 10 parts by mass
Ethylene glycol: 10 parts by mass
Propylene glycol: 10 parts by mass
Glycerin: 10 parts by mass
Surfactant: 0.5 parts by mass
Proxel GXL (manufactured by Lonza Japan Ltd., 1,2-benzisothiazolin-3-one, antifungal agent): 0.10 parts by mass
Ion-exchanged water: Remaining part

### 1-3. Overcoat Layer-Forming Liquid

The following components were mixed in the following proportions based on 100 parts by mass of the overcoat layer-forming liquid to obtain an overcoat layer-forming liquid.
AQUACER531 (manufactured by BYK) as an agent containing wax particles: 10 parts by mass
Ethylene glycol: 10 parts by mass
Propylene glycol: 10 parts by mass
Glycerin: 10 parts by mass
Surfactant E-1010: 0.1 parts by mass
Proxel GXL (manufactured by Lonza Japan Ltd., 1,2-benzisothiazolin-3-one, antifungal agent): 0.10 parts by mass
Ion-exchanged water: Remaining part

### 2. Textile-Printed Image Formation

As the fabric, cotton satin (100% cotton: product name 60 cotton satin, manufactured by Okadaya Co., Ltd.) was prepared. Each of the pretreatment liquid, the inkjet ink, and the overcoat layer-forming liquid described above was applied to the cotton satin by an inkjet method and then dried, thereby obtaining a textile-printed image formed product. Konica Minolta Head #204 was used as the recording head. The ejection of the pretreatment liquid, the inkjet ink, and the overcoat layer-forming liquid from each recording head was performed with the main scanning 540 dpi×and the sub-scanning 720 dpi. Note that dpi represents the number of ink droplets (dots) per 2.54 cm. The ejection frequency was set to 22.4 kHz. Then, drying was performed at 150° C. for 5 minutes by a belt conveying type dryer to obtain a textile-printed image formed product. The adhesion amounts of the pre-treatment layer, the fixing layer, and the overcoat layer were 1 g/m², 6 g/m², and 3 g/m², respectively. The adhesion amount was obtained from the ink ejection amount.

### 3. Evaluation

The friction fastness, texture, and ejectability were evaluated as follows.

### (Friction Fastness)

The resulting image formed product was subjected to a dry rubbing fastness test using a Type II tester in accordance with the drying conditions of JIS L0849 (2013), and evaluated using a discoloration/fading gray scale. To be specific, the portion where the image was formed was rubbed with a cotton fabric by moving back and forth 100 times in 100 mm areas in the horizontal direction and the vertical direction under a load of a 200 g. After the rubbing, the density of the color deposited on the cotton fabric was determined by a grade corresponding to the same density in the discoloration/fading gray scale. The higher the grade, the better the friction fastness.
∘: Fourth to fifth level to fifth level
Δ: Third to fourth level to fourth level
x: Second to third level to third level

### (Ejectability)

The inkjet ink for textile printing was ejected by a line method with a fixed KM1024iMHE manufactured by Konica Minolta, Inc. under the ejection conditions of a droplet ejection amount of 13 pL. After it was confirmed that the filling ink was ejected from all 60 nozzles at the start of ejection, the ink was continuously ejected for 60 minutes. Then, after the completion of the continuous ejection for 60 minutes, the number of nozzles that were able to eject until the end (the number of ejection nozzles after the completion of the continuous ejection for 60 minutes) was counted. The number of ejection nozzles after completion of continuous ejection for 60 minutes was applied to the following evaluation criteria to evaluate the ejectability of the ink.
∘: No white adhered substance was on the inkjet head, and the number of ejection nozzles after completion of continuous ejection for 60 minutes was 60 or more
Δ: No white adhered substance was on inkjet head, but the number of ejection nozzles after completion of continuous ejection for 60 minutes was 54 to 59
x: A white adhered substance was on the inkjet head, and the number of ejection nozzles after completion of continuous ejection for 60 minutes was 53 or less

Table 1 shows the evaluation results.

### Examples 2 to 5 and Comparative Examples 1 to 6

In Examples 2 to 5 and Comparative Examples 1 to 6, an overcoat layer-forming liquid and an inkjet ink was produced in the same manner as in Example 1 except that the composition and the like of the overcoat forming liquid or the inkjet ink were changed as illustrated in Table 1.

In Example 2, AQUACER-531 was contained in an amount of 5 parts by mass (5% by mass) based on 100 parts by mass of the overcoat layer-forming liquid, thus the amount thereof was larger than that in Example 1.

In Example 3, 3% by mass of a polyurethane-based resin (TAKELAC WS-5000, Tg 65° C., manufactured by Mitsui Chemicals, Inc) was added as fixing resin particles to the overcoat layer-forming liquid.

In Example 4, Hitec E-6314 (manufactured by Toho Chemical Industries, Ltd., volume average particle diameter: 180 nm, melting point: 137° C.) was used instead of AQUACER-531.

In Example 5, AQUACER-539 (manufactured by BYK, volume average particle diameter: 90 nm, melting point: 90° C.) was used instead of AQUACER-531.

In Comparative Example 1, no wax particles were contained in the overcoat layer-forming liquid.

In Comparative Example 2, no fixing resin particles were contained in the inkjet ink.

In Comparative Example 3, no wax particles were contained in the overcoat layer-forming liquid, and instead, 1 part by mass (1% by mass) of AQUACER-531 was included in the inkjet ink based on 100 parts by mass of the inkjet ink.

In Comparative Example 4, no wax particles were contained in the overcoat layer-forming liquid, and instead, 10 parts by mass (10% by mass) of AQUARCER-531 was contained in the inkjet ink based on 100 parts by mass of the inkjet ink.

In Comparative Example 5, instead of drying at 150° C. for 5 minutes, drying was performed at 120° C. for 5 minutes to obtain a textile-printed image formed product.

In Comparative Example 6, AQUACER-507 (manufactured by BYK, volume average particle diameter 50 nm, melting point of 130° C.) was used instead of AQUACER-531.

TABLE 1

| | Overcoat layer-forming liquid | | | | | | |
|---|---|---|---|---|---|---|---|
| | | | | | Fixing | | |
| | Wax particles | | | | resin particles | | |
| | | | Average | Amount | Amount | Average | |
| | | Melting | particle | of | of | particle | Inkjet ink |
| | | point | diameter | addition | addition | diameter | Wax particles |
| | Type | (° C.) | (nm) | (%) | (%) | (nm) | Type |
| Ex. 1 | AQUACER- | 130 | 180 | 1 | | | |
| | 531 | | | | | | |
| Ex. 2 | AQUACER- | 130 | 180 | 5 | | | |
| | 531 | | | | | | |
| Ex. 3 | AQUACER- | 130 | 180 | 1 | 3 | 35 | |
| | 531 | | | | | | |
| Ex. 4 | Hitec E- | 137 | 100 | 1 | | | |
| | 6314 | | | | | | |
| Ex. 5 | AQUACER- | 90 | 100 | 1 | | | |
| | 539 | | | | | | |
| Comp. | | | | | | | |
| Ex. 1 | | | | | | | |
| Comp. | AQUACER- | 130 | 180 | 1 | | | |
| Ex. 2 | 531 | | | | | | |
| Comp. | | | | | | | AQUACER- |
| Ex. 3 | | | | | | | 531 |
| Comp. | | | | | | | AQUACER- |
| Ex. 4 | | | | | | | 531 |
| Comp. | AQUACER- | 130 | 180 | 1 | | | |
| Ex. 5 | 531 | | | | | | |
| Comp. | AQUACER- | 130 | 50 | 1 | | | |
| Ex. 6 | 507 | | | | | | |

| | Inkjet ink | | | | | | | |
|---|---|---|---|---|---|---|---|---|
| | | | | Fixing | | | | |
| | Wax particles | | | resin particles | | | | |
| | | Average | Amount | Amount | Average | Drying | | |
| | Melting | particle | of | of | particle | temper- | Evaluation | |
| | point | diameter | addition | addition | diameter | ature | Friction | Eject- |
| | (° C.) | (nm) | (%) | (%) | (nm) | (° C.) | fastness | ability |
| Ex. 1 | | | | 10 | 35 | 150 | ∘ | ∘ |
| Ex. 2 | | | | 10 | 35 | 150 | ∘ | ∘ |
| Ex. 3 | | | | 10 | 35 | 150 | ∘ | ∘ |
| Ex. 4 | | | | 10 | 35 | 150 | ∘ | ∘ |
| Ex. 5 | | | | 10 | 35 | 150 | ∘ | ∘ |
| Comp. | | | | 10 | 35 | 150 | x | ∘ |
| Ex. 1 | | | | | | | | |
| Comp. | | | | | | 150 | x | ∘ |
| Ex. 2 | | | | | | | | |
| Comp. | 130 | 180 | 1 | 10 | 35 | 150 | x | Δ |
| Ex. 3 | | | | | | | | |
| Comp. | 130 | 180 | 10 | 10 | 35 | 150 | ∘ | x |
| Ex. 4 | | | | | | | | |
| Comp. | | | | 10 | 35 | 120 | x | ∘ |
| Ex. 5 | | | | | | | | |
| Comp. | | | | 10 | 35 | 150 | x | ∘ |
| Ex. 6 | | | | | | | | |

As shown in Table 1, in Examples 1 to 5, both the friction fastness and the ejectability were satisfactory, whereas in Comparative Example 6, the friction fastness was poor. The reason is that the volume average particle diameter of the wax particles contained in the overcoat layer-forming liquid is twice or more the volume average particle diameter of the fixing resin particles contained in the inkjet ink in Examples 1 to 5, whereas the volume average particle diameter of the wax particles is less than twice the volume average particle diameter of the fixing resin particles in Comparative Example 6. That is, it is presumed that in Examples 1 to 5, since the wax particles contained in the overcoat layer-forming liquid were sufficiently large, a wax layer was easily formed on the surface of the textile-printed image after drying, and thus the friction fastness became satisfactory.

When Example 1 and Comparative Example 1 are compared, in Comparative Example 1, the overcoat layer-forming liquid did not contain wax particles, and the friction fastness was poor. From this, it has been found that in order to improve the friction fastness, it is necessary to add wax particles in the overcoat layer-forming liquid.

In comparison of Example 1 and Comparative Example 2, the inkjet ink did not contain fixing resin particles and the friction fastness was unsatisfactory in Comparative Example 2. From this, it was found that the inkjet ink is required to contain the fixing resin particles in order to improve the friction fastness

When Example 1 and Comparative Example 3 are compared, in Comparative Example 3, the overcoat layer-forming liquid does not contain wax particles, but instead, the inkjet ink contains 1% by mass of wax particles. Such a comparative example 3 had unsatisfactory friction fastness. From this, it was found that even when a small amount of wax particles was contained in the inkjet ink in an attempt to improve the friction fastness, the friction fastness was not improved. This is presumed to be because even when a small amount of wax particles is added to the inkjet ink, the wax particles are covered with the resin particles and the pigment in the inkjet ink, and the amount of the wax present on the surface of the textile-printed image after drying is insufficient.

When Comparative Example 3 and Comparative Example 4 are compared, in Comparative Example 4, the inkjet ink contains 10% by mass of wax particles with respect to the inkjet ink. In Comparative Example 4, the friction fastness was satisfactory, but the ejectability was unsatisfactory. From these, it has been found that when an attempt is made to enhance the friction fastness by adding a wax into the inkjet ink, the ejectability becomes poor.

From the above, it was found that when the wax particles are contained in the overcoat forming liquid, the friction fastness can be improved even in a small amount.

In comparison of Example 1 and Comparative Example 5, the drying temperature was as low as 120° C. and the friction fastness was unsatisfactory in Comparative Example. This is probably because in Comparative Example 5, the drying temperature was lower than the melting point of the wax particles, and thus no wax layer was formed on the surface of the textile-printed image. Therefore, it was found that the melting point of the wax particles contained in the overcoat layer-forming liquid is preferably equal to or lower than the drying temperature. In addition, it was found that the drying temperature is preferably equal to or higher than the melting point of the wax particles.

### INDUSTRIAL APPLICABILITY

According to the present invention, it is possible to obtain an ink set having satisfactory ejectability while achieving satisfactory friction fastness. Therefore, the present invention is expected to broaden the range of textile-printed image forming technologies and contribute to the development and spread of technologies in the same field.

Although embodiments of the present invention have been described in detail, it is clearly understood that the same is by way of example only and not limitation, the scope of the present invention should be interpreted by terms of the appended claims.

What is claimed is:

1. An ink set for textile printing, the ink set comprising an inkjet ink and an overcoat layer-forming liquid, wherein
a volume average particle diameter of a wax particle contained in the overcoat layer-forming liquid is twice or more a volume average particle diameter of a fixing resin particle contained in the inkjet ink.

2. The ink set for textile printing according to claim 1, wherein the fixing resin particle has a glass transition temperature of −35° C. or lower.

3. The ink set for textile printing according to claim 1, wherein the wax particle has a melting point of 80 to 140° C.

4. The ink set for textile printing according to claim 1, wherein a content of the wax particle contained in the overcoat layer-forming liquid is 0.1% by mass to 10% by mass with respect to the overcoat layer-forming liquid.

5. The ink set for textile printing according to claim 1, the ink set further comprising a pretreatment liquid containing a cationic dispersant or a cationic resin.

6. The ink set for textile printing according to claim 1, wherein the overcoat layer-forming liquid contains an anionic resin.

7. An image forming apparatus comprising an ink container that stores the ink set for textile printing according to claim 1.

8. An image forming method using the ink set according to claim 1, the method comprising performing drying at a temperature equal to or higher than a melting point of the wax particle.
